(19) United States
(12) Patent Application Publication
(10) Pub. No.: US 2016/0034132 A1
(43) Pub. Date: Feb. 4, 2016

(54) SYSTEMS AND METHODS FOR MANAGING DISPLAYED CONTENT ON ELECTRONIC DEVICES

(71) Applicant: GOOGLE TECHNOLOGY HOLDINGS LLC, Mountain View, CA (US)

(72) Inventors: Meng Huang, Beijing (CN); Qi Li, Beijing (CN); Wei Zhong, Beijing (CN)

(21) Appl. No.: 14/775,148

(22) PCT Filed: Mar. 13, 2013
(86) PCT No.: PCT/CN2013/072553

§ 371 Date: Sep. 11, 2015

(51) Int. Cl. G06F 3/0488; G06F 3/01; G06F 3/041

(52) U.S. Cl. CPC G06F 3/0488; G06F 3/0416; G06F 3/017; G06F 2203/04804

(57) ABSTRACT

Systems and methods are provided for managing navigation among applications installed on an electronic device. According to certain aspects, an electronic device detects (905) a triggering of a multi-task mode associated with a first application and second application. The electronic device controls (910) operation of the first application based on a first touch event detected on a first side. Further, the electronic device detects (925) a second touch event on a second side and controls (935) operation of the second application based on the second touch event. In some embodiments, the electronic device can copy (920) an element from the first application and add (970) the element to the second application.

### FIELD

This application generally relates to managing the content displayed on an electronic device. In particular, the application relates to platforms and techniques for enabling users to easily and effectively toggle or switch between applications displayed on an electronic device and transfer content between the applications.

### BACKGROUND

Many electronic devices support operation of various installed applications. For example, the applications can be social networking applications, personalization applications, imaging applications, utility applications, productivity applications, news applications, games, and/or other types of applications. Some of the electronic devices enable users to facilitate and control the operation and functionalities of the applications via a touch sensitive display, such as a capacitive touch screen. Some electronic devices include an additional touch pad that enables users to control various functionalities of a given application.

The combination of the multiple touch elements of existing electronic devices enable users to control navigation of only a single application, such as the application that is currently “focused” or active on the display. Accordingly, there is an opportunity to enable users to control the operations and navigations of multiple applications operating on and displayable by the electronic devices. Additionally, there is an opportunity to enable users to effectively and efficiently transfer content between and among multiple displayed applications via interfacing with multiple touch components.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 depicts a perspective view of an example electronic device in accordance with some embodiments.

FIG. 2 depicts another view of an example electronic device in accordance with some embodiments.

FIG. 3 depicts an example interface and interactions associated with navigating between displayed applications in accordance with some embodiments.

FIG. 4 depicts an example interface and interactions associated with navigating between displayed applications in accordance with some embodiments.

FIG. 5 depicts an example interface and interactions associated with transferring content between applications in accordance with some other embodiments.

FIG. 6 depicts an example interface and interactions associated with transferring content between applications in accordance with some other embodiments.

FIG. 7 depicts an example interface and interactions associated with transferring content between applications in accordance with some other embodiments.

FIG. 8 illustrates various timing options available for user interaction with an electronic device in accordance with some embodiments.

FIG. 9 depicts a flow diagram of managing content on an electronic device in accordance with some embodiments.

FIG. 10 is a block diagram of an electronic device in accordance with some embodiments.

### DETAILED DESCRIPTION

Systems and methods enable an electronic device to efficiently and effectively manage the display and transfer of content, interface elements, or other interface data associated with multiple applications operating on the electronic device. The electronic device can initially display multiple overlapping application windows whereby one window is active or “focused.” According to embodiments, the electronic device can include multiple touch-sensitive input components either with or without display capabilities. In some cases, the electronic device can be a handheld device with a touch-sensitive display on its front side and a touch-sensitive surface such as a touch pad on its opposite side.

The electronic device can support a “multi-task” mode wherein a user can control, via the touch-sensitive components, which application or combinations of applications the electronic device displays. In some cases, the electronic device can toggle between displayed applications in response to the user selecting respective touch-sensitive components. The electronic device can also enable the user to transfer content between applications via interfacing with the touch-sensitive components. According to embodiments, the electronic device can enable the user to select an element or content from a first application and, responsive to detecting a gesture, can overlay a window of the first application with a second application window such that at least a portion of each of the first and second application is visible. When the user selects the second application (such as via contacting only the one of the touch-sensitive components), the electronic device can transfer or paste the selected element into the interface of the second application. In some cases, the electronic device can move the selected element within the second application based on movement associated with the user's contact on the appropriate touch-sensitive component.

The systems and methods offer a benefit by enabling users to efficiently and effectively navigate among multiple launched applications via interfacing with multiple touch-sensitive components. Instead of users having to manually navigate among applications, such as via various inputs of a single input component, the systems and methods enable the user to toggle between displayed applications via gestures and selections associated with the multiple touch-sensitive components. Further, the systems and methods enable users to effectively and efficiently transfer selected elements and content between applications via similar gestures and touch selections. Accordingly, the method may reduce the amount of steps and time necessary to both switch between displayed applications, and copy and paste content between applications.

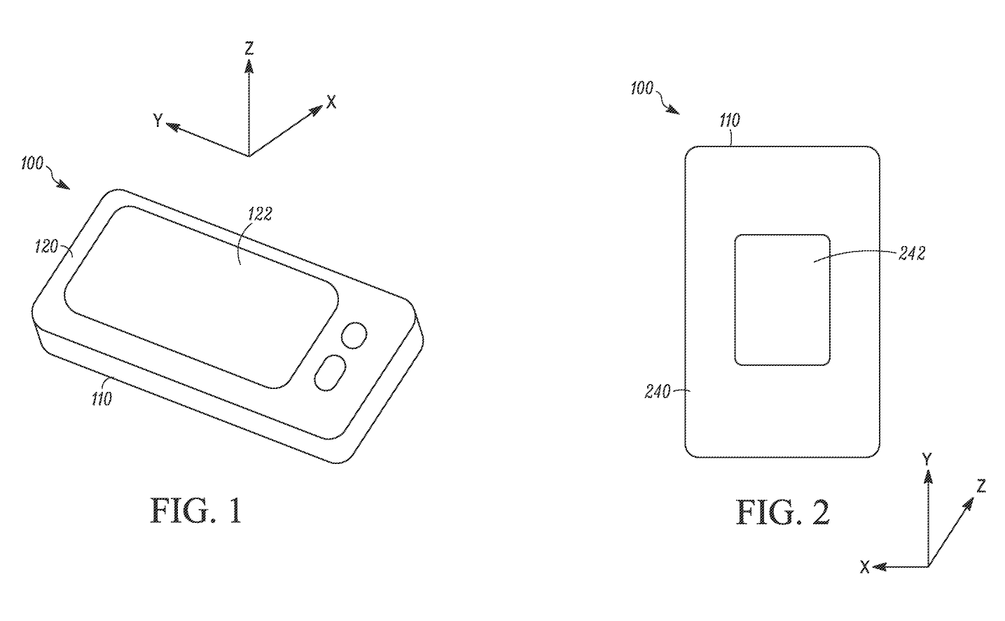

FIG. 1 is a front perspective view of an electronic device 100 according to an example embodiment. The device 100 may be, for example, a handheld wireless device, such as a mobile phone, a Personal Digital Assistant (PDA), a smart phone, a tablet or laptop computer, a multimedia player, an MP3 player, a digital broadcast receiver, a remote controller, or any other electronic apparatus. Many embodiments may be portable and hand-held, but this is not required. In one example embodiment, the device 100 is a cellular phone that exchanges information with a network (not shown in FIG. 1). In another embodiment, the device 100 may be, for example, an electronic book (eBook) reader.

The device 100 can include an electronic device housing 110. The housing 110 may include a front (obverse or first) housing face 120. In general, the front housing face 120 is the surface that faces the user during active use. The device 100 can further include a touch screen display (or first touch sensitive surface) 122 positioned on the front housing face 120. The front touch screen display 122 can be integrated into the front housing face 120 and can be configured as both a display screen and a manual user interface. In this way, the user may view displayed information and provide manual touch inputs upon the front touch screen display 122. In one example embodiment, the front touch screen display 122 may be a capacitive sensor touch screen display. The front touch screen display 122 may also be a resistive touch screen, an inductive touch screen, a surface acoustic wave touch screen, an infrared touch screen, a strain gauge touch screen, an optical imaging touch screen, a dispersive signal technology touch screen, a proximity type touch screen, or any other touch screen that can be used on an electronic device and support single and/or multi-touch user inputs. Although not described, the housing 110 may support any number of additional user input structures, including buttons, switches, keyboards, joystick, and/or the like.

FIG. 2 is a rear view of the device 100 of FIG. 1 according to an example embodiment. FIG. 2 particularly illustrates a rear (reverse or second) housing face 240 of the housing 110 that is substantially opposite the front housing face 120 of FIG. 1. A rear touch pad 242 can be positioned on the rear housing face 240 and is configured as another user interface. The rear touch pad 242 may be a capacitive sensor touch pad, a resistive touch pad, an inductive touch pad, a surface acoustic wave touch pad, an infrared touch pad, a strain gauge touch pad, an optical imaging touch pad, a dispersive signal technology touch pad, or any other touch pad that can be used on a handheld electronic device and support single and/or multi-touch user inputs.

Referring now to FIGS. 1 and 2, the front touch screen display 122 and rear touch pad 242 are configured to receive various touch inputs for operating the device 100, including operating the device 100 in a number of touch pad modes in which varying functions are implemented or executed via the rear touch pad 242. Although the front touch screen display 122 is described as being on the front housing face 120 and the rear touch pad 242 is described as being on the rear housing face 240, the positions of front touch screen display 122 and the rear touch pad 242 may be reversed or incorporated onto a common side. Alternately, the rear touch pad 242 may be positioned on a side (lateral) housing face relative to the front touch screen display 122. Also, the rear touch pad 242 may be positioned on another housing element, such as a cover housing element (not shown). Additionally, the front touch screen display 122 or rear touch pad 242 may each be a composite of two or more touch sensitive surfaces to receive, for example, multi-touch gestures or provide additional functionality.

In general, the device 100 may be sized to fit the hand of the user such that a first digit of the supporting hand provides inputs on the rear touch pad 242 while another digit of the supporting hand or a digit of the other hand provides inputs on the front touch screen display 122. For example, the thumb of the user may actuate the front touch screen display 122 while the index finger may actuate the rear touch pad 242. Such inputs at the front touch screen display 122 and/or the rear touch pad 242 may be functions associated with a picture viewer application, a view finder application, a web browser application, a map application, a media player application, a phonebook application, a game application, or any other application. The input actuation may be based on tap inputs, gesture inputs, or combinations of such inputs on the front touch screen display 122 and/or rear touch pad 242. For example, a tap input can be a temporary press on the front touch screen display 122 and/or the rear touch pad 242 and a gesture may be a single or double point sliding input or multiple sliding inputs on the front touch screen display 122 and/or the rear touch pad 242. The gestures can be substantially linear gestures along a horizontal or vertical axis, gestures at an angle to a horizontal or vertical axis, arced gestures, or gestures that are a combination of horizontal, vertical, angled, and/or arced gestures.

In general and as noted above, the user inputs on the front touch screen display 122 and/or the rear touch pad 242 control the operation of the device 100 in one of a number of predetermined modes, each of which may include a set of functions such as data entry, icon selection, highlighting, copying, cutting or pasting of an image or text, and zooming, moving, rotating, and otherwise manipulating an image on the touch screen display 122. Other functions include media player control function, a contact or directory function, search function, camera actuation, Internet browsing, and telephone functions. At least some of the functions associated with the front touch screen display 122 and the rear touch pad 242, as well as the interaction thereof, are discussed in further detail below.

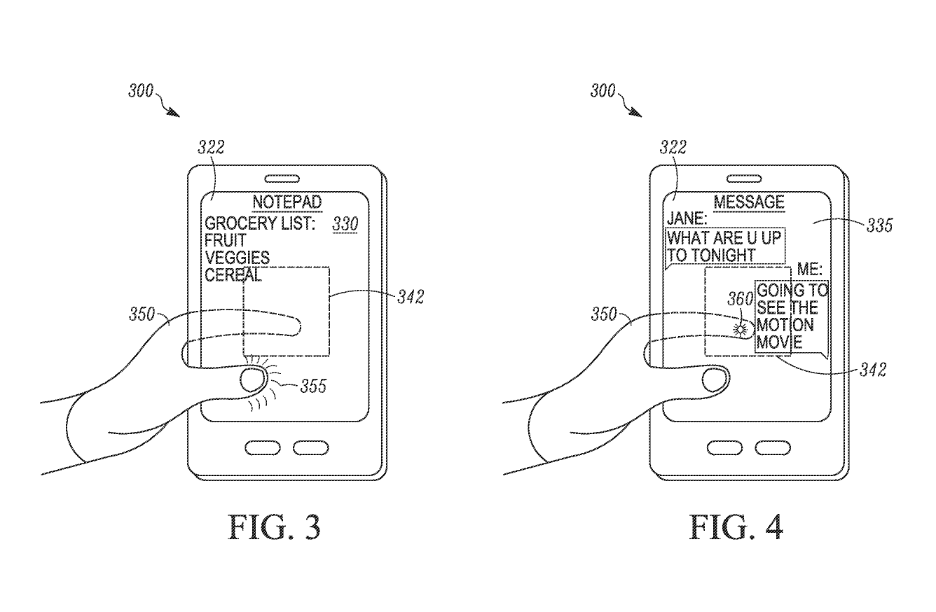

Referring to FIGS. 3-4, depicted are two example interfaces of a device 300 (similar to the device 100 as described with respect to FIGS. 1 and 2) that illustrate the systems and methods as described herein. It should be appreciated that the interfaces are merely an example and can include and/or exclude other components, elements, and options, as well as other various combinations of components, elements, and options. Further, it should be appreciated that a front touch screen display 322 can display the example interfaces and can be capable of receiving inputs, commands, instructions, and the like from a user of the electronic device. According to embodiments, the user can select various graphical items within the interfaces according to various techniques, including via various touchscreen gestures, keyboard inputs, stylus interactions, input from peripheral I/O components, and others.

In some cases, the device 300 can display the example interfaces while in a multi-task mode. According to the systems and methods, the device 300 can enter the multi-task mode in response to detecting various triggers, such as a hard key input, a soft key input, voice control, a tap input or inputs, a gesture detected via the front touch screen display 322, a gesture detected via the rear touch pad 342, a dual gesture detected via the front touch screen display 322 and the rear touch pad 342, or other triggers. For example, as discussed herein, a tap input can be a temporary press on the front touch screen display 322 and/or the rear touch pad 342, and a gesture may be a single or double point sliding input or multiple sliding inputs on the front touch screen display 322 and/or the rear touch pad 342. The gestures can be substantially linear gestures along a horizontal or vertical axis, gestures at an angle to a horizontal or vertical axis, arced gestures, or gestures that are a combination of horizontal, vertical, angled, and/or arced gestures. According to some embodiments, while in the multi-task mode, the device 300 can enable the user 350 to select various elements or content displayed within the appropriate interface. It should be appreciated that the device 300 can also enable the user 350 to select various elements or content while not in the multi-task mode.

FIG. 3 depicts an example interface 330 associated with a notepad application. The notepad application can enable a user 350 to compose or otherwise access notes, as generally understood and as shown in the interface 330. In some embodiments, the user 350 can activate or otherwise cause the device 300 to display the interface 330 in response to making a touch contact 355 with the front touch screen display 322. It should be appreciated that the front touch screen display 322 can display the interface 330 without detecting the touch event 355, such as in cases in which the notepad application is already executing, operating, or otherwise displaying. It should further be appreciated that the device 300 can display the interface 330 in response to detecting other touch events, gestures, or the like. As shown in FIG. 3, a digit (e.g., an index finger) of the user 350 can be positioned to make contact with a rear touch pad 342, similar to the rear touch pad 242 as described with respect to FIG. 2.

FIG. 4 depicts an example interface 335 associated with a messages application is depicted. The messages application can enable the user 350 to compose, respond to, or otherwise access messages (e.g., SMS, MMS, or other types of data communications), as generally understood and as shown in the interface 335. In some embodiments, the user 350 can activate or otherwise cause the device 300 to display the interface 335 in response to making a touch event 360 with the rear touch pad 342. It should further be appreciated that the device 300 can display the interface 335 in response to detecting other touch events, gestures, or the like. In embodiments, the device 300 can toggle the interfaces 330, 335 in response to detecting respective touch events 355, 360 by the user 350. In other words, the user 350 can control which of the applications is active, focused, displayed, or the like based on making the appropriate touch events 355, 360 with the appropriate front touch screen display 322 or rear touch pad 342.

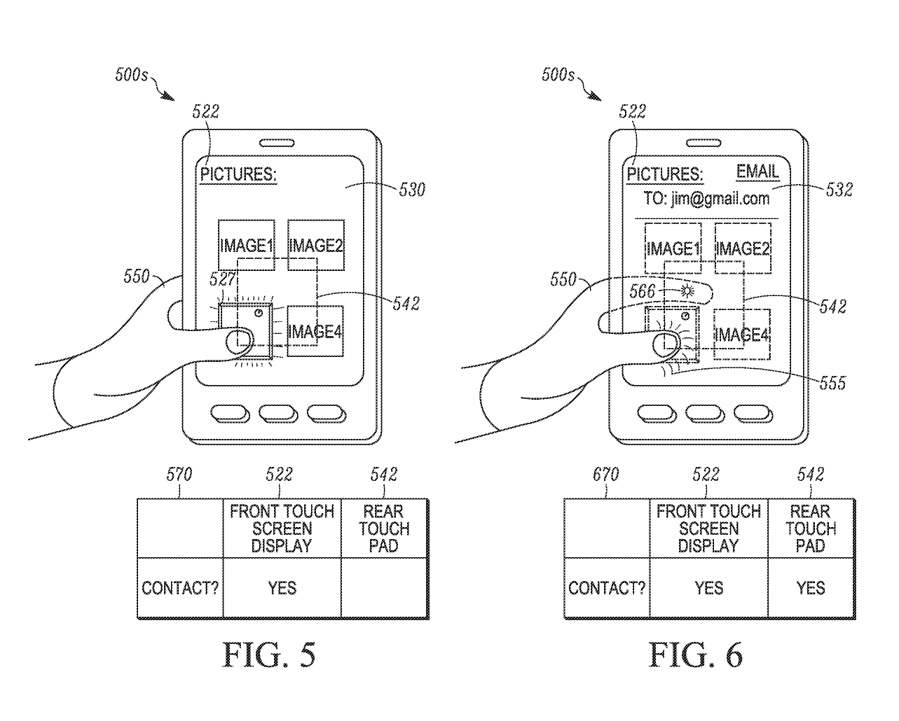

FIGS. 5-7 depict three example interfaces of a device 500 (similar to the devices 100, 300 as described with respect to FIGS. 1-4) that illustrate further embodiments of the systems and methods as described herein. In particular, FIGS. 5-7 illustrate functionality whereby a user 550 can copy content (e.g., text, graphics, and/or the like) from one application to another application via touch events and gestures detected by a front touch screen display 522 and a rear touch pad 542. It should be appreciated that “content” or an “element” as used herein can be any content that is selectable for transferring between (e.g., copying from and pasting into) various interfaces associated with applications. For example, content or an element can be text, an icon, a graphic, a snippet, a fragment, and/or any other textual, graphical, or multimedia content.

It should be appreciated that the interfaces are merely an example and can include and/or exclude other components, elements, and options, as well as other various combinations of components, elements, and options. Further, it should be appreciated that the front touch screen display 522 can display the example interfaces and can be capable of receiving inputs, commands, instructions, and the like from a user of the electronic device. According to embodiments, the user can select various content and elements within the interfaces according to various techniques, including via various touchscreen gestures, keyboard inputs, stylus interactions, input from peripheral I/O components, and others. In some cases, the device 500 can enable the tranferring functionalities while in a multi-task mode, as discussed herein.

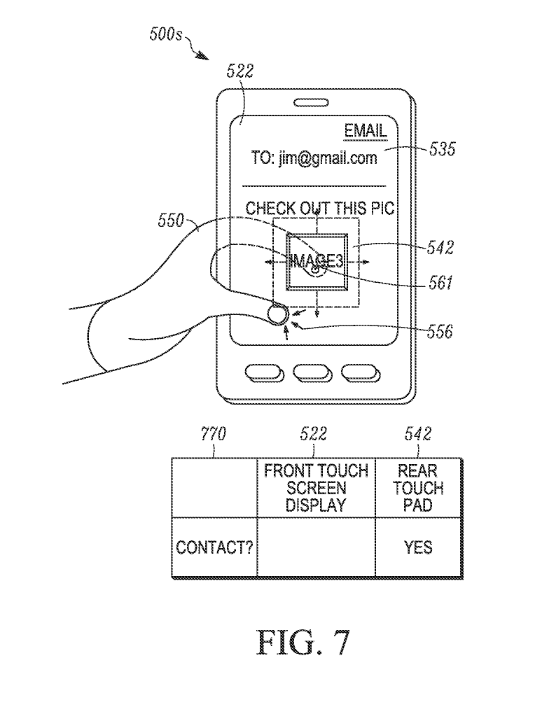

FIG. 5 depicts an example interface 530 associated with a pictures application. The pictures application can enable the user 550 to view, select, transmit, or otherwise access various images, as generally understood and as shown in the interface 530. As discussed herein, the user 550 can activate or otherwise cause the device 500 to display the interface 530 in response to making a touch contact with the front touch screen display 522. It should be appreciated that the front touch screen display 522 can display the interface 530 without detecting the touch event, such as in cases in which the pictures application is already executing, operating, or otherwise displaying. According to embodiments, the device 500 can display the interface 530 as overlapping another interface 535 corresponding to an email application (as shown in FIG. 7). The system and methods enable the device 500 to display and switch between the interfaces 530, 535, and perform functionalities therein, in response to detecting various touch events and gestures.

As shown in FIG. 5, the user 550 can select an image 527 via, for example, a touch event, contact, gesture, or the like with the front touch screen display 522. According to some embodiments, in response to detecting a selection of the image 527, the device 500 can transfer the image data to memory (such as via a clipboard function), faciliate a memory share between the pictures application and the email application operating on the device 500, facilitate a UNIX or Java local socket command, or the like. In some embodiments, the user 550 can drag the selected image 527 throughout the interface 530, such as via maintaining contact with the original touch event. Further, the device 500 can highlight the image 527 to indicate to the user 550 that the image 527 is selected, as shown in FIG. 5.

According to embodiments, the device 500 can detect when the user 550 selects both the pictures application and the email application. For example, as shown in FIG. 6, the device 500 can detect a touch event 555 with the front touch screen display 522 and a touch event 560 with the rear touch pad 542. It should be appreciated that the device 500 can detect when both applications are selected according to other triggers. In embodiments, the device 500 can display an interface 532 in response to detecting the touch events 555, 560. The interface 532 depicts a visual effect whereby parts or sections of both the picture application and the email application interfaces are visible. As shown in FIG. 6, the interface 532 illustrates faded depictions of the applications whereby each application interface includes a transparency effect. Accordingly, either or both of the applications are partially visible (or partially obscured). It should be appreciated that the device 500 can render the interface 532 according to other various effects to simulate partial visibility (or partial obscurity) of at least respective portions of the picture application and the email application. In some embodiments, the device 500 can maintain the display of the interface 532 so long as the user 550 maintains both touch events 555, 560.

In embodiments, the device 500 can transition from the interface 532 to the interface 535 in response to various triggers. For example, the device 500 can initiate the transition in response to the user 550 releasing the touch event 555 (as depicted by the arrows 556 in FIG. 7). In other words, the device 500 can display the “dual application” interface 532 when the user 550 maintains both touch events 555, 560 and then can display the email application interface 535 when the user 550 releases the touch event 555. According to embodiments, the device 500 can enable the user 550 to select to paste or insert the selected image 527 (or other element) within the email application. The user 550 can maintain contact with a touch event 561 (which can be the same as or different from the touch event 560) to position the selected image 527 within the interface 535 (as depicted by the arrows in FIG. 7). In particular, as the user 550 moves the touch event 561 on the rear touch pad 542, the device 500 can correspondingly “drag” the selected image 527 throughout the interface 535. In embodiments, the area covered by the rear touch pad 542 can correspond to the area covered by the front touch screen display 522 (i.e., the top right corner of the rear touch pad 542 (viewed from the front of the device 500) corresponds to the top right corner of the front touch screen display 522, and so on). Further, in embodiments, the rear touch pad 542 can be smaller than (as shown in FIGS. 1-7), larger than, or the same size as the front touch screen display 522.

In response to the device 500 detecting that the user 550 releases the touch event 561, the device 500 can insert the selected image 527 into the email application (i.e., can display the selected image 527 within the email application at the location associated with the release of the touch event 561). In particular, the device 500 can retrieve the data corresponding to the selected image 527 from memory (such as via a clipboard function), via a memory share between the pictures application and the email application operating on the device 500, via a UNIX or Java local socket command, or via the like.

FIGS. 5-7 further indicate charts 570, 670, 770 that indicate which of the front touch screen display 522 or the rear touch pad 542 is detecting contact when the device is displaying the corresponding interface 530, 532, 535. In particular, the chart 570 indicates that the front touch screen display 522 senses contact when the device displays the interface 530, the chart 670 indicates both the front touch screen display 522 and the rear touch pad 542 sense contact when the device displays the interface 532, and the chart 770 indicates the rear touch pad 542 senses contact when the device displays the interface 535.

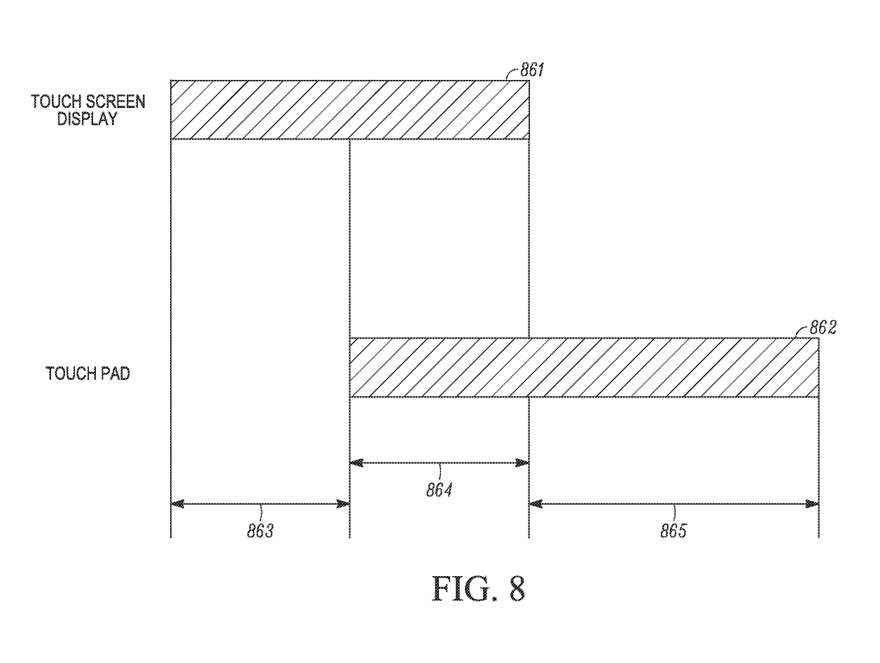

FIG. 8 illustrates various timing options available for user interaction with the touch screen display (such as the front touch screen display 522) and the touch pad (such as the rear touch pad 542). As shown, a first touch interaction 861 occurs on the touch screen display of an electronic device. This first touch interaction 861 has a positive time duration as shown. After starting the first touch interaction 861 and before ending the first touch interaction 861, a second touch interaction 862 occurs on the touch pad of the electronic device. A period of time 863 elapsed between the commencement of the first touch interaction 861 and the commencement of the second touch interaction 862 may be any positive value time period, including a zero time elapsed—which means that the first touch interaction 861 and the second touch interaction 862 commenced at almost the same time. (The tolerance for a “zero time elapsed” determination may be set by a manufacturer setting, a user-configurable setting, or through a learning process by the electronic device.) According to embodiments, during the period of time 863, the electronic device can display a first application and enable a user to select an element of the first application, as discussed herein.

Both the first touch interaction 861 and the second touch interaction 862 continue for a period of time 864. During the period of time 864, the electronic device can overlay interfaces of both the first application and a second application such that at least a portion of each of the first and second applications is visible (or obscured). In some embodiments as described herein, the electronic device can vary transparency effects of the interfaces to accomplish the display of both of the interfaces in varying degress of visibility. The user can release the first touch interaction 861 before completing the second touch interaction 862 as shown in FIG. 8, resulting in a time period 865 in which the electronic device only detects the second touch interaction 862. During the time period 865, the electronic device can display the second application and enable a user to transfer the selected element into the second application. In some cases, the electronic device can transfer the selected element in response to detecting a release of the second touch interaction 562.

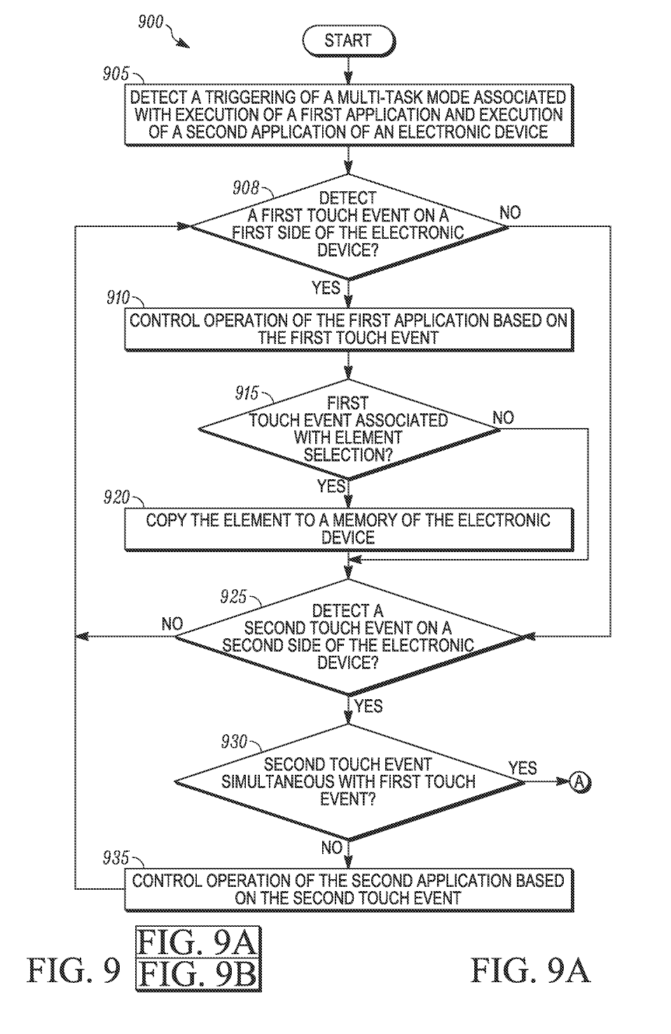

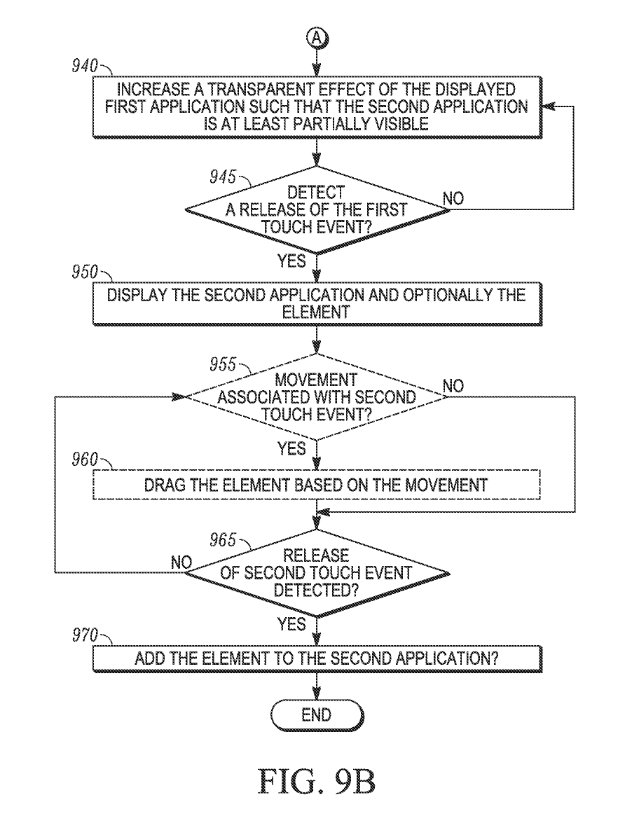

FIG. 9 is a flowchart of a method 900 for an electronic device to manage content displayed on the electronic device. The method 900 begins with the electronic device detecting 905 a triggering of a multi-task mode associated with execution of a first application and execution of a second application of an electronic device. In embodiments, the electronic device can display the first and second applications in overlapping windows. Further, the electronic device can detect the triggering via a hard key input, a soft key input, a voice command, a tap input or inputs, a gesture on one or more of a first side or a second side of the electronic device, or other triggers. The electronic device determines 908 whether a first touch event is detected on a first side of the electronic device. For example, the electronic device can detect the first touch event via a touch screen display. If the electronic device detects the first touch event (“YES”), the electronic device controls 910 operation of the first application based on the first touch event. The electronic device determines 915 whether the first touch event is associated with an element selection. For example, the electronic device can determine an element selection based on how long of a contact is associated with the touch event (e.g., a “touch-and-hold” gesture).

If the electronic device determines that the first touch event is an element selection (“YES”), the electronic device copies 920 the element to a memory of the electronic device. In embodiments, the electronic device can transfer the element data to memory (such as via a clipboard function), faciliate a memory share between the first application and the second application, facilitate a UNIX or Java local socket command, or the like. If the electronic device determines that the first touch event is not an element selection (“NO”) or if the electronic device does not detect the first touch event (“NO”), the electronic device determines 925 whether a second touch event is detected on a second side of the electronic device. For example, the electronic device can detect the second touch event via a rear touch pad. If the electronic device does not detect the second touch event (“NO”), processing can return to 908 (or other processing). If the electronic device detects the second touch event (“YES”), the electronic device determines 930 whether the second touch event is simultaneous with the first touch event (i.e., if the electronic device determines that the first touch event and the second touch event are being made at the same time). If the electronic device determines that the touch events are not simultaneous (“NO”), the electronic device controls 935 operation of the second application based on the second touch event and returns to 908 (or performs other functions). In this regard, a user can toggle between displays of the first application and the second touch application via the first and second touch events.

If the electronic device determines that the touch events are simultaneous, processing can proceed to “A” in which the electronic device increases 940 a transparent effect of the displayed first application such that the second application is at least partially visible. It should be appreciated that various degrees of transparency are envisioned such that the first and second applications can be various degrees of visibility (or invisibility). The electronic device determines 945 whether the first touch event has been released. If the electronic device determines that the first touch event has not been released (“NO”), processing can return to 940 (or other processing). If the electronic device determines that the first touch event has been released (“YES”), the electronic device displays 950 the second application and optionally a copy of the element if an element has previously been selected. In some embodiments, the electronic device can position the element graphic based on the position of the second touch event.

The electronic device optionally determines 955 if there is movement associated with the second touch event. The movement can be based on the user of the electronic device dragging the second touch event via a rear touch pad of the electronic device. If the electronic device detects movement (“YES”), the electronic device optionally drags 960 the element graphic based on the movement. In particular, the electronic device can display a dragging effect for the element as the user correspondingly drags the second touch event. If the electronic device does not detect movement (“NO”), the electronic device determines 965 if the second touch event has been released. If the electronic device determines that the second touch event has not been released (“NO”), processing can return to 955 (or to other processing). If the electronic device determines that the second touch event has been released (“YES”), the electronic device adds 970 the element to the second application. In embodiments, the electronic device can retrieve the element data from memory (such as via a clipboard function), faciliate a memory share between the first application and the second application, facilitate a UNIX or Java local socket command, or the like. Responsive to adding the element to the second application, the electronic device can enable the user to exit the multi-task mode, or can return to 908 or other processing.

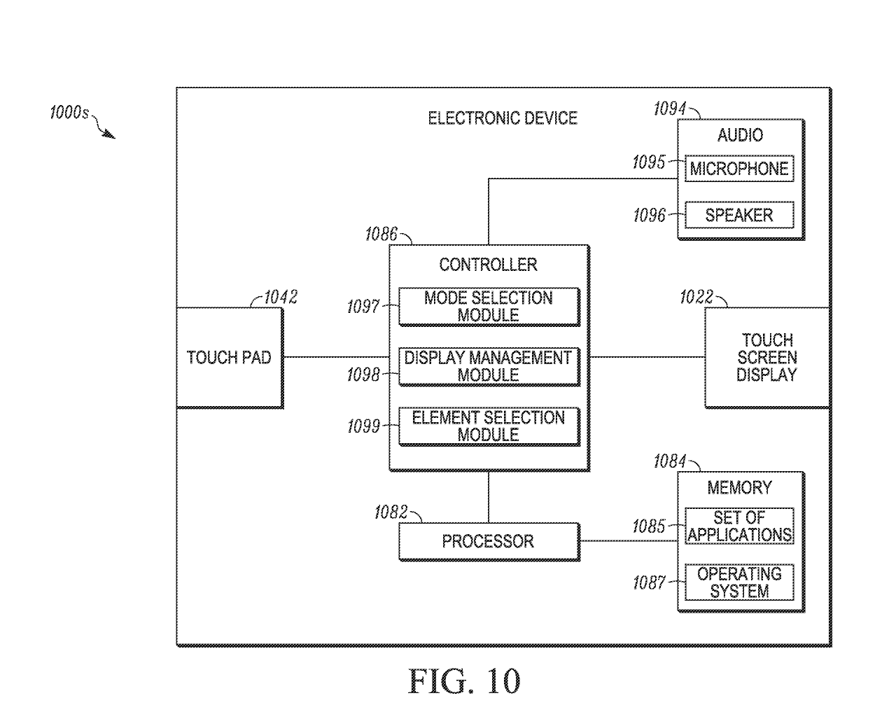

FIG. 10 illustrates a simplified block diagram of an electronic device 1000 with a touch screen display 1022 and a touch pad 1042. As shown, the touch screen display 1022 is on an obverse side of the electronic device 1000 and the touch pad 1042 is on a reverse side of the electronic device 1000. In other embodiments, however, the touch pad 1042 could be on the top of the electronic device 1000, the bottom of the electronic device 1000, or even on the obverse side of the electronic device 1000 along with the touch screen 1022. As noted previously, the touch screen display 1022 and the touch pad 1042 are examples of touch-sensitive surfaces, and the touch pad 1042 can be replaced with a second touch screen in an alternate embodiment. The electronic device 1000 also has a controller 1086 coupled to the touch pad 1042 and the touch screen display 1022. The controller 1086 is coupled to a processor 1082. In other embodiments, the controller 1086 may be integrated into a single controller or into the processor 1082. According to embodiments, the processor 1082 receives signals from the touch screen display 1022, the touch pad 1042, and audio components 1094 such as a microphone 1095 via the controller 1086 and directs signals to the touch screen display 1022 and/or the audio components 1094 such as a speaker 1096 via the controller 1086.

A memory 1084 coupled to the processor 1082 stores a set of applications 1085 (such as the first application and the second application as discussed herein) for manipulating graphical user interface elements in accordance with the systems and methods described herein, an operating system 1087, and various data files. The memory 1084 can include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

When executing the various applications 1085 and/or the operating system 1087, the processor can interface with various modules of the controller 1086, namely, a mode selection module 1097, a display management module 1098, and an element selection module 1099. According to embodiments, the mode selection module 1097 can be configured to enable a multi-task mode associated with execution of various of the set of applications 1085, as discussed herein. The multi-task mode can enable a user of the electronic device 1000 to toggle between displays of two or more of the set of applications 1085 as well as transfer content between or among the applications. The display management module 1098 can be configured to control the display of the associated interfaces of the set of applications 1085 responsive to detected touch events via the touch pad 1042 and/or the touch screen display 1022. The element selection module 1099 can be configured to select an element based on touch events detected via the touch pad 1042 and/or the touch screen display 1022, as well as copy the element to and retrieve the element from the memory 1086. It should be appreciated that the processor 1082 in combination with the controller 1086 can interpret various detected touch events and gestures to cause the touch screen display 1022 to change as directed by the processor 1082.

The electronic device 1000 can also include a variety of other components (not shown) based on the particular implementation. For example, if the electronic device 1000 was implemented as a mobile phone, it would also include a wireless transceiver and optionally additional input components such as a keypad, accelerometer, and vibration alert. If the electronic device 1000 was implemented as a remote controller, an infrared transmitter could also be included.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 1082 (e.g., working in connection with the operating system 1087) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

Thus, it should be clear from the preceding disclosure that the systems and methods offer improved application navigation techniques. The systems and methods advantageously enable electronic devices to toggle between displayed applications via multiple touch-sensitive components. The systems and methods improve the user experience by improving users' ability to navigate among displayed applications as well as transfer content and data among the applications.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of managing applications of an electronic device, the method comprising:
detecting a triggering of a multi-task mode associated with operation of a first application and a second application, each of the first application and the second application executing on the electronic device and displaying in overlapping windows;
controlling operation of the first application displayed on the electronic device based on a first touch event detected on a first side of the electronic device; and
responsive to detecting a second touch event on a second side of the electronic device, controlling operation of the second application displayed on the electronic device.

2. The method of claim 1, wherein the controlling the operation of the first application comprises:
selecting an element displayed by the first application based on the first touch event.

3. The method of claim 2, wherein the selecting the element comprises:
copying the element to a memory of the electronic device.

4. The method of claim 2, wherein the controlling the operation of the second application comprises:
determining that the first touch event and the second touch event are maintained simultaneously;
increasing a transparency effect of the displayed first application such that the second application is at least partially visible; and
based on detecting a release of the first touch event, displaying the second application and the element, the element positioned based on the second touch event.

5. The method of claim 4, further comprising:
based on detecting a release of the second touch event, adding the element to the second application.

6. The method of claim 5, wherein the adding the element to the second application comprises:
dragging the element based on movement of the second touch event; and
based on detecting the release of the second touch event, adding the element to the second application at a location based on the movement.

7. The method of claim 1, wherein the triggering of the multi-task mode is detected via at least one of a hard key input, a soft key input, or voice control.

8. The method of claim 1, wherein the triggering of the multi-task mode is detected via at least one tap input.

9. The method of claim 1, wherein the triggering of the multi-task mode is detected via at least one of a gesture on the first side, a gesture on the second side, or a dual gesture on the first side and the second side.

10. The method of claim 1, wherein the controlling the operation of the second application comprises:
displaying the second application so as to obscure at least part of the display of the first application.

11. An electronic device comprising:
a housing having a first side and a second side;
a touch-sensitive display on the first side;
a touch-sensitive surface on the second side; and
a user input controller including:
a mode selection module configured to enable a multi-task mode associated with execution of a first application and execution of a second application, and
a display management module configured to:
control operation of the first application displayed on the touch-sensitive display based on a first touch event detected via the touch-sensitive display, and
responsive to detecting a second touch event via the touch-sensitive surface, control operation of the second application displayed on the touch-sensitive display.

12. The electronic device of claim 11, wherein the user input controller further includes an element selection module for selecting an element of the first application based on the first touch event.

13. The electronic device of claim 12, further comprising a memory, wherein the element selection module is configured to copy the selected element to the memory.

14. The electronic device of claim 12, wherein the display management module controls the operation of the second application by:
determining that the first touch event and the second touch event are maintained simultaneously;
increasing a transparency effect of the displayed first application such that the second application is at least partially visible; and
based on detecting a release of the first touch event, displaying the second application and the element, the element positioned based on the second touch event.

15. The electronic device of claim 14, wherein the display management module is further configured to:
based on detecting a release of the second touch event, add the element to the second application.

16. The electronic device of claim 15, wherein the display management module adds the element to the second application by:
dragging the element based on movement of the second touch event; and
based on detecting the release of the second touch event, adding the element to the second application at a location based on the movement.

17. The electronic device of claim 15, further comprising a memory, wherein the display management module adds the element to the second application by:
retrieving the element from the memory; and
pasting the element within the second application.

18. The electronic device of claim 11, wherein the touch-sensitive display has a larger surface area size than that of the touch-sensitive surface.

19. The electronic device of claim 11, wherein the display management module controls the operation of the second application by:
displaying the second application on the touch-sensitive display such that the first application displayed on the touch-sensitive display is at least partially obscured by the second application.

20. The electronic device of claim 11, wherein the mode selection module enables the multi-task mode in response to detecting at least one of a gesture on the touch-sensitive display, a gesture on the touch-sensitive surface, or a dual gesture on the touch-sensitive display and the touch-sensitive surface.
